(19) United States
(12) Patent Application Publication
(10) Pub. No.: US 2012/0242613 A1
(43) Pub. Date: Sep. 27, 2012

(54) PROJECTED CAPACITIVE TOUCH PANEL

(76) Inventor: Jane HSU, Taoyuan County (TW)

(21) Appl. No.: 13/333,414

(22) Filed: Dec. 21, 2011

(30) Foreign Application Priority Data
Mar. 23, 2011 (TW) 100205143

(51) Int. Cl. G06F 3/044

(52) U.S. Cl. 345/174

(57) ABSTRACT

A projected capacitive touch panel has a substrate and at least two sensing units. The sensing units form an active region as an operating zone for users. Because the active region is divided into smaller ranges, the path in which electric signals are transported becomes shorter. The electric signals can be outputted to an outer processor effectively. Additionally, when the projected capacitive touch panel of this invention is mounted on a display, the influence of the electromagnetic interference from the display can be decrease.

### CROSS-REFERENCE TO RELATED APPLICATIONS

This application claims the benefit of the Taiwan patent application No. 100205143, filed on Mar. 23, 2011, the disclosure of which is incorporated herein in its entirety by reference.

### BACKGROUND OF THE INVENTION

1. Field of the Invention

The present invention relates to a capacitive touch panel, and more particularly to a projected capacitive touch panel.

2. Description of Related Art

With reference to U.S. patent publication No. 2010/0245285, a capacitive touch panel includes a transparent substrate, a plurality of first sensing electrode sets and second sensing electrode sets provided on the transparent substrate. Each first sensing electrode set includes a plurality of first sensing electrodes electrically coupled in series through a plurality of first wires. Each second sensing electrode set includes a plurality of second sensing electrodes. A color compensation layer having a mesh-like pattern is provided between the first sensing electrodes and the second sensing electrodes. The second wires cover part of the surface of the color compensation layer to couple the second sensing electrodes in series.

To achieve the purpose of using a computer conveniently, a touch panel formed on a display takes the place of a traditional input device such as a keyboard or a mouse.

A common type of touch panel is a projected capacitive touch panel. The projected capacitive touch panel mainly comprises a substrate and a sensing layer formed on a bottom surface of the substrate. The sensing layer is composed of multiple sensing wires and electrically connected to a processor via signal wires connected between the sensing layer and the processor. Because a human body will carry electric charges, when a human body touches a top surface of the substrate of the touch panel, a capacitive signal between the human body and the sensing layer changes. The capacitive signal is outputted to the processor via the signal wires. The processor will calculate the coordinates of a touch point on the touch panel touched by the person based on the capacitive signal. The processor will then change the scenes of the display accordingly.

The display is composed of multiple electric components, such as a backlight module and a power module, and the arrangement of signal wires in the display is complicated. As the display is activated, the display will induce the electromagnetic interference around the touch panel.

The sensing wires of the sensing layer and the signal wires formed on the touch panel may be spread widely and densely as a result of the size and arrangement of the signal wires. Therefore, the electromagnetic interference on the touch panel will be more obvious. Moreover, as the path of the sensing layer and the signal wires in which the electric signals are transported becomes longer, the wire resistance of the sensing layer and the signal wires are raised, causing more serious reduction of the electric signals. As a result, the sensitivity of the touch panel is decreased.

### SUMMARY OF THE INVENTION

An objective of the present invention is to provide a projected capacitive touch panel having a substrate and at least two sensing units.

The substrate has two opposite surfaces.

The at least two sensing units are formed on the surface of the substrate. The sensing units are electrically insulated from each other. Each sensing unit comprises multiple X-axis sensing wires, multiple Y-axis sensing wires and multiple driving wires. Each X-axis sensing wire intersects each Y-axis sensing wire. The driving wires are electrically connected to the X-axis sensing wires and the Y-axis sensing wires respectively.

Another objective of the present invention is to provide a projected capacitive touch panel. The projected capacitive touch panel has a bottom substrate, at least two bottom sensing units, a top substrate, at least two top sensing units and an insulating-adherent layer.

The bottom substrate has a top surface.

The bottom sensing units are formed on the top surface of the bottom substrate, and each bottom sensing unit is insulated from each other.

Each bottom sensing unit comprises multiple first axis sensing wires and multiple driving wires connected to the multiple first axis sensing wires respectively.

The top substrate has a bottom surface.

The top sensing units are formed on the bottom surface of the top substrate, and each top sensing unit is insulated from each other. Each top sensing unit comprises multiple second axis sensing wires and multiple driving wires connected to the multiple second axis sensing wires respectively. The multiple second axis sensing wires intersect the multiple first axis sensing wires.

The insulating-adherent layer is formed between the bottom substrate and the top substrate to bind the bottom substrate to the top substrate and avoid the electric connection between the bottom substrate and the top substrate.

In contrast to the description of related art, the at least two divided and insulated sensing units in this invention form an active region as a touch-sensing interface. After the dividing, the range of each sensing unit is decreased. The path in which the electric signals are transported is shortened. Therefore, the electromagnetic interference from the display is effectively improved, and the wire resistance of the sensing units is decreased, raising the sensitivity of the touch panel.

### BRIEF DESCRIPTION OF THE DRAWINGS

FIG. 1 is a top view of two sensing units of a capacitive touch panel in accordance with the present invention;

FIG. 2 is a top view of the projected capacitive touch panel with X-axis sensing wires and Y-axis sensing wires;

FIG. 3 is a side view of a second embodiment of a capacitive touch panel in accordance with the present invention; and

FIG. 4 is an exploded perspective view of a third embodiment of a capacitive touch panel in accordance with the present invention.

### DETAILED DESCRIPTION OF THE PREFERRED EMBODIMENT

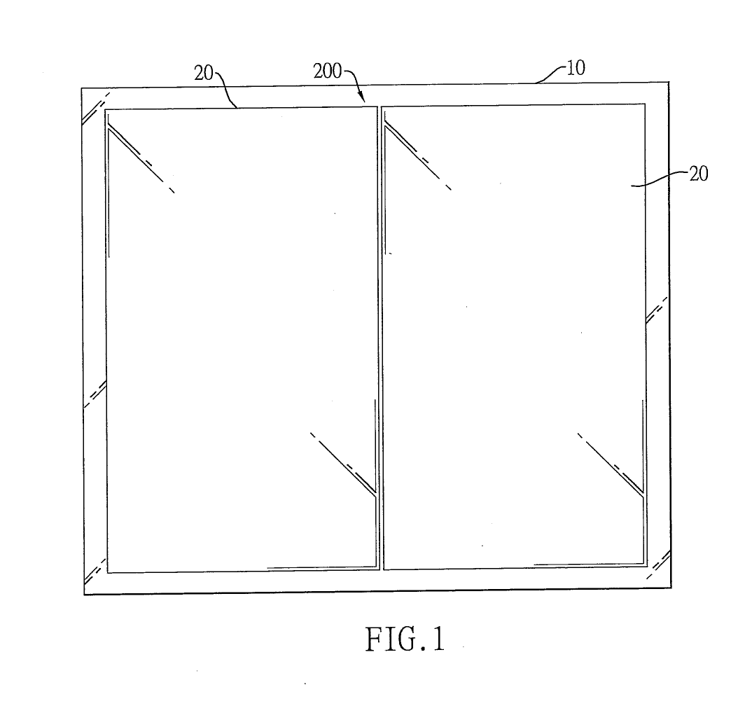

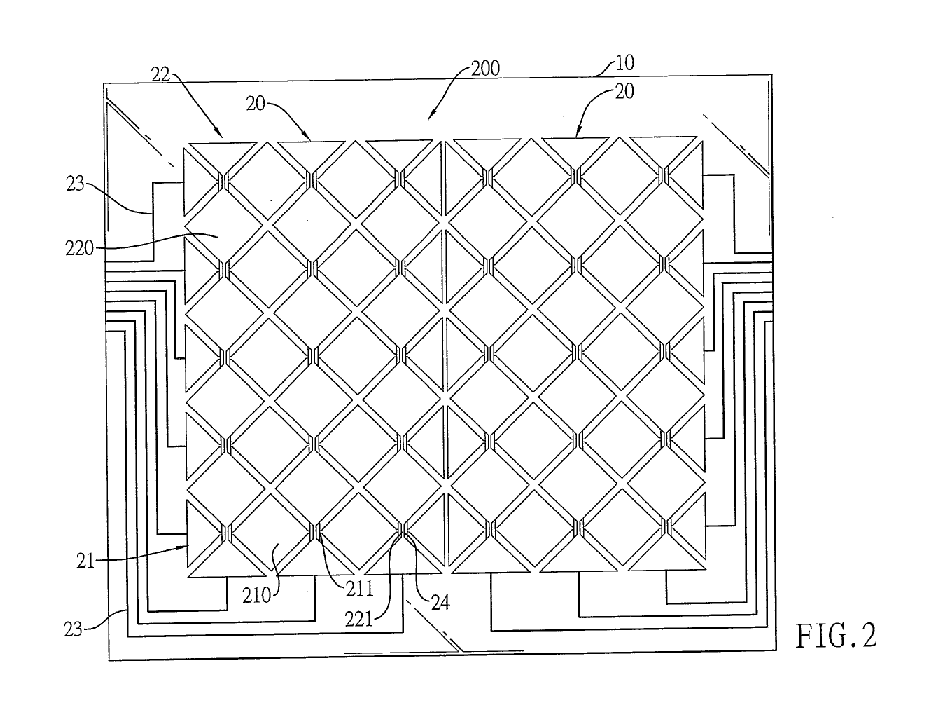

With reference to FIG. 1 and FIG. 2, a first embodiment of a projected capacitive touch panel in accordance with the present invention has a substrate 10 and at least two sensing units 20.

The substrate 10 has two opposite surfaces. The at least two sensing units 20 are formed on the same surface of the substrate 10. The sensing units 20 are electrically insulated from each other and form an active region 200 as a touch-sensing interface.

Each sensing unit 20 comprises multiple X-axis sensing wires 21, multiple Y-axis sensing wires 22, multiple driving wires 23 and multiple insulators 24. Each X-axis sensing wire 21 vertically and insulatedly intersects each Y-axis sensing wire 22. The driving wires 23 are electrically connected to the X-axis sensing wires 21 and the Y-axis sensing wires 22 respectively. The multiple X-axis sensing wires 21 and the multiple Y-axis sensing wires 22 are electrically connected to a processor via the driving wires 23. Each X-axis sensing wire 21 is composed of multiple X-axis electrodes 210 and multiple X-axis connection bridges 211. Each X-axis connection bridge 211 is connected between every two adjacent X-axis electrodes 210 respectively. Each Y-axis sensing wire 22 is composed of multiple Y-axis electrodes 220 and multiple Y-axis connection bridge 221. Each Y-axis connection bridge 221 is connected between every two adjacent Y-axis electrodes 220 respectively. Each insulator 24 is formed between every intersection between the X-axis sensing wires 21 and the Y-axis sensing wires 22 to avoid the electric connection between the X-axis sensing wires 21 and the Y-axis sensing wires 22.

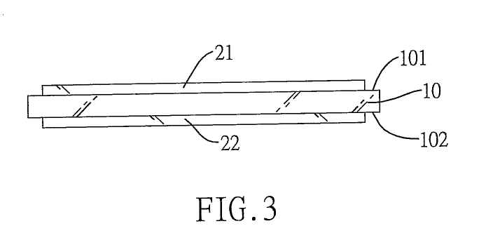

With reference to FIG. 3, in a second embodiment of the projected capacitive touch panel in accordance with the present invention, the two opposite surfaces of the substrate 10 stand for a top surface 101 and a bottom surface 102 respectively. The X-axis sensing wires 21 may be formed on the top surface 101, and the Y-axis sensing wires 22 may be formed on the bottom surface 102. The X-axis sensing wires 21 are not electrically connected to the Y-axis sensing wires 22.

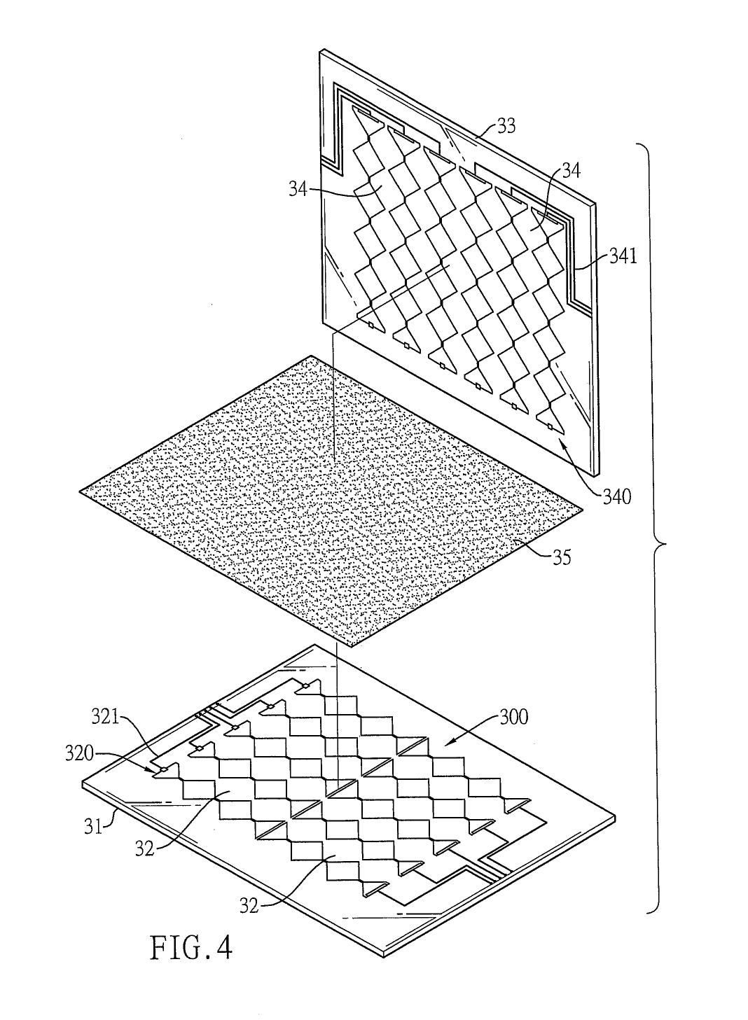

With reference to FIG. 4, a third embodiment of the projected capacitive touch panel in accordance with the present invention has a bottom substrate 31, at least two bottom sensing units 32, a top substrate 33, at least two top sensing units 34 and an insulating-adherent layer 35.

The bottom substrate 31 has a top surface. The bottom sensing units 32 are formed on the top surface of the bottom substrate 31, and the bottom sensing units 32 are insulated from each other. The bottom sensing units 32 form an active region 300. Each bottom sensing unit 32 comprises multiple first axis sensing wires 320 and multiple driving wires 321. The driving wires 321 are electrically connected to the multiple first axis sensing wires 320 respectively.

The top substrate 33 has a bottom surface. The top sensing units 34 are formed on the bottom surface of the top substrate 33, and the top sensing units 34 are insulated from each other. Each top sensing unit 34 comprises multiple second axis sensing wires 340 and multiple driving wires 341. The driving wires 341 are electrically connected to the multiple second axis sensing wires 340 respectively. The multiple second axis sensing wires 340 are vertically and insulatedly formed across the multiple first axis sensing wires 320. If the axis of the first axis sensing wires 320 is X axis, the axis of the second axis sensing wires 340 will be Y axis. If the axis of the first axis sensing wires 320 is Y axis, the axis of the second axis sensing wires 340 will be X axis.

The insulating-adherent layer 35 is applied between the bottom substrate 31 and the top substrate 33 to bind the bottom substrate 31 to the top substrate 33 and avoid the electric connection between the bottom substrate 31 and the top substrate 33.

With reference to FIG. 1 and FIG. 2 as an explanatory example, the active region 200 is composed of at least two divided sensing units 20 and the sensing units 20 are insulated from each other. Each sensing unit 20 has its own driving wires 23 electrically connected to the processor. According to the size of the whole substrate 10 and the active region 200, because the active region 200 is divided into smaller ranges and also the sensing units 20 are formed on the smaller ranges respectively, the length of the sensing wires of the sensing units 20 is decreased. That means the path in which the electric signals are transported is shortened. Therefore, the electric signals can be effectively transported in the sensing units 20, and the electromagnetic interference induced from the display can be effectively reduced. In addition, with the shortened path in which the electric signals are transported, the wire resistance is decreased. The transporting attenuation of the electric signals is improved. The sensitivity of the touch panel will be promoted, and the misoperations will be reduced thereof.

The active region of the embodiments mentioned above is composed of two sensing units 20. However, the active region can be composed of more sensing units 20, according to practical demands such as the larger size of the touch panel.

Even though numerous characteristics and advantages of the present invention have been set forth in the foregoing description, together with details of the structure and features of the invention, the disclosure is illustrative only. Changes may be made in the details, especially in matters of shape, size and arrangement of parts within the principles of the invention to the full extent indicated by the broad general meaning of the terms in which the appended claims are expressed.

What is claimed is:

1. A projected capacitive touch panel comprising:
a substrate having two opposite surfaces; and
at least two sensing units formed on the substrate wherein the sensing units are electrically insulated from each other and each sensing unit comprises:
multiple Y-axis sensing wires;
multiple X-axis sensing wires intersecting the Y-axis sensing wires insulatedly; and
multiple driving wires connected to the X-axis sensing wires and the Y-axis sensing wires respectively.

2. The projected capacitive touch panel as claimed in claim 1, wherein:
each X-axis sensing wire comprises:
multiple X-axis electrodes; and
multiple X-axis narrow connection bridges, each X-axis narrow connection bridge connected between every two adjacent X-axis electrodes; and
each Y-axis sensing wire comprises:
multiple Y-axis electrodes; and
multiple Y-axis narrow connection bridges, each Y-axis narrow connection bridge connected between every two adjacent Y-axis electrodes.

3. The projected capacitive touch panel as claimed in claim 2, wherein
the X-axis sensing wires and the Y-axis sensing wires are formed on the same surface; and
an insulator is applied between each intersection between the X-axis sensing wires and the Y-axis sensing wires.

4. The projected capacitive touch panel as claimed in claim 1, wherein the X-axis sensing wires and the Y-axis sensing wires are formed on the opposite surfaces of the substrate respectively.

5. The projected capacitive touch panel as claimed in claim 2, wherein the X-axis sensing wires and the Y-axis sensing wires are formed on the opposite surfaces of the substrate respectively.

6. A projected capacitive touch panel comprising
a bottom substrate having a top surface;
multiple bottom sensing units formed on the top surface of the bottom substrate and each bottom sensing unit being insulated from each other and each bottom sensing unit comprising
multiple first axis sensing wires; and
multiple driving wires connected to the multiple first axis sensing wires respectively;
a top substrate having a bottom surface;
multiple top sensing units formed on the bottom surface of the top substrate and each top sensing unit being insulated from each other and each top sensing unit comprising
multiple second axis sensing wires intersecting the multiple first axis sensing wires; and
multiple driving wires connected to the multiple second axis sensing wires respectively; and
an insulating-adherent layer formed between the bottom substrate and the top substrate to bind the bottom substrate to the top substrate.

7. The projected capacitive touch panel as claimed in claim 6, wherein
the axis of the first axis sensing wires is X axis and each first axis sensing wire comprises
multiple X-axis electrodes; and
multiple X-axis narrow connection bridges, each X-axis narrow connection bridge connected between every two adjacent X-axis electrodes; and
the axis of the second axis sensing wires is Y axis and each second axis sensing wire comprises
multiple Y-axis electrodes; and
multiple Y-axis narrow connection bridges, each Y-axis narrow connection bridge connected between every two adjacent Y-axis electrodes.

8. The projected capacitive touch panel as claimed in claim 6, wherein
the axis of the first axis sensing wires is Y axis and each first axis sensing wire comprises
multiple Y-axis electrodes; and
multiple Y-axis narrow connection bridges, each Y-axis narrow connection bridge connected between every two adjacent Y-axis electrodes; and
the axis of the second axis sensing wires is X axis and each second axis sensing wire comprises
multiple X-axis electrodes; and
multiple X-axis narrow connection bridges, each X-axis narrow connection bridge connected between every two adjacent X-axis electrodes.
